(19) United States
(12) Patent Application Publication
(10) Pub. No.: US 2026/0104004 A1
(43) Pub. Date: Apr. 16, 2026

(54) SWIRL GENERATING INTAKE PORTS FOR INTERNAL COMBUSTION ENGINES

(71) Applicant: Cummins Inc., Columbus, IN (US)

(72) Inventors: Robert G. Sperry, Columbus, IN (US); David M. Barnes, Columbus, IN (US)

(21) Appl. No.: 19/114,643

(22) PCT Filed: Oct. 3, 2023
(86) PCT No.: PCT/US2023/075776

§ 371 Date: Mar. 24, 2025

Related U.S. Application Data
(60) Provisional application No. 63/378,400, filed on Oct. 5, 2022.

(51) Int. Cl. F02B 31/04; F02F 1/42

(52) U.S. Cl. CPC F02B 31/04; F02F 1/425

(57) ABSTRACT

An internal combustion engine includes a cylinder head configured to generate swirl in the charge flow introduced into the combustion chamber. The cylinder head includes a first port for receiving a first portion of the charge flow. The first port is configured to provide the first portion of the charge flow to a combustion chamber of the internal combustion engine. The cylinder head includes second port for receiving a second portion of the charge flow, and a swirl passage connecting an upstream portion of the second port to a downstream portion of the first port.

### CROSS-REFERENCE TO RELATED APPLICATION

The present application claims priority to, and the benefit of the filing date of, U.S. Provisional Application Ser. No. 63/378,400 filed on Oct. 5, 2023, which is incorporated herein by reference.

### TECHNICAL FIELD

This invention relates to internal combustion engines and, more particularly, to intake ports configured to generate swirl in combustion chambers of internal combustion engines.

### BACKGROUND

A cylinder head for an internal combustion engine may include two intake valve openings into the combustion chamber that are opened and closed by respective first and second intake valves. The valve openings are connected to respective ones of first and second intake ports that distribute the charge flow from the intake manifold to the respective intake valve openings.

Swirl of the charge flow in the combustion chamber is desirable to aid in mixing with fuel and to provide proper and complete combustion. In order to generate swirl in the combustion chamber, one of the intake ports may include a swirl inducing configuration. However, such configurations typically induce pumping losses, so the amount of beneficial swirl that can be generated is offset by pumping losses required to produce the desired flow through the intake ports. Therefore, further improvements in this technological area are desired.

### SUMMARY

Systems and devices are disclosed herein relating to an internal combustion engine with intake ports that are configured to generate swirl in a combustion chamber.

In an embodiment, an internal combustion engine includes at least one cylinder including a combustion chamber. A cylinder head is configured to provide a charge flow to the combustion chamber. The cylinder head includes a first port connected to a first outlet. The first port is configured to introduce charge flow into the combustion chamber through the first outlet. The cylinder head includes a second port connected to a second outlet. The second port is configured to introduce charge flow into the combustion chamber through the second outlet. A swirl passage connects an upstream portion of the second port to a downstream portion of the first port. The swirl passage is configured to generate a swirl in the charge flow introduced into the combustion chamber through the first outlet with charge flow diverted from the second port to the first port through the swirl passage.

In an embodiment, a cylinder head for distributing a charge flow to an internal combustion engine in provided. The cylinder head includes a first port for receiving a first portion of a charge flow. The first port is configured to provide the first portion of the charge flow to a combustion chamber of the internal combustion engine. The cylinder head includes a second port for receiving a second portion of the charge flow. The cylinder head includes a swirl passage connecting an upstream portion of the second port to a downstream portion of the first port. The swirl passage is configured divert a part of the second portion of the charge flow from the second port to the first port to generate swirl in the charge flow in the combustion chamber with a remaining part of the second portion of the charge flow being provided to the combustion chamber through the second port.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic diagram of an internal combustion engine according to one embodiment of the present disclosure.

FIG. 2 is a section view through a cylinder of the internal combustion engine of FIG. 1 showing an intake port arrangement in the cylinder head according to an embodiment of the present disclosure.

FIG. 3 is a partial section view of a cylinder head and intake manifold of the internal combustion engine of FIG. 1 showing an intake port arrangement along the cylinder head according to one embodiment of the present disclosure.

FIG. 4 is an elevation view of the cylinder head along line 4-4 of FIG. 3.

FIG. 5 is an elevation view of the intake port arrangement of a cylinder of FIG. 3.

FIG. 6 is a plan view of the intake port arrangement of a cylinder of FIG. 3.

FIG. 7 is a schematic diagram of the intake port arrangement of FIG. 3.

FIG. 8 is a schematic diagram showing a cylinder port configuration in the cylinder head according to an embodiment of the present disclosure.

FIG. 9 is a schematic diagram showing another embodiment of a cylinder port configuration in the cylinder head according to the present disclosure.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

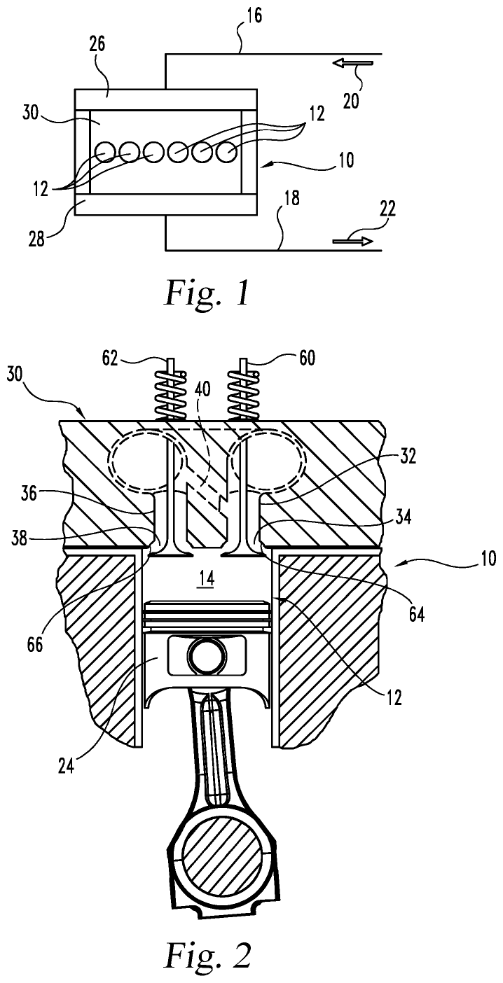

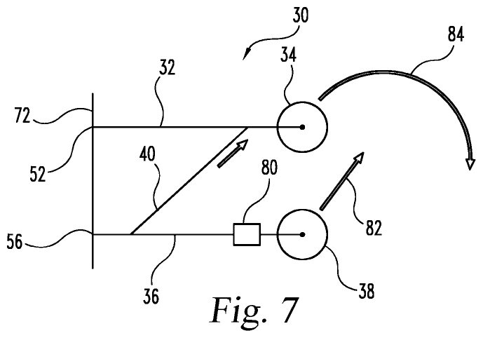

FIGS. 1-9 show various aspects of an internal combustion engine 10. Internal combustion engine 10 includes at least one cylinder 12 and a cylinder head 30. The cylinder head 30 includes a combustion chamber 14. The cylinder head 30 is configured to provide a charge flow 20 to the combustion chamber 14. The cylinder head 30 includes a first port 32 connected to a first outlet 34 of the first port 32, and a second port 36 connected to a second outlet 38 of the second port 36. The first port 32 is configured to introduce charge flow 20 into the combustion chamber 14 through the first outlet 34, and the second port 36 is configured to introduce charge flow 20 into the combustion chamber 14 through the second outlet 38. A swirl passage 40 connects an upstream portion 46 of the second port 36 to a downstream portion 44 of the first port 32. The swirl passage 40 is configured to generate a swirl in the charge flow 20 introduced into the combustion chamber 14 through the first outlet 34 with charge flow 20 diverted from the second port 36 to the first port 32 through the swirl passage 40.

Also disclosed is a cylinder head 30 for distributing the charge flow 20 within an internal combustion engine 10. The cylinder head 30 includes the first port 32 for receiving a first portion of the charge flow 20. The first port 32 is configured to provide the first portion of the charge flow 20 to the combustion chamber 14 of the internal combustion engine 10. The cylinder head 30 includes the second port 36 for receiving a second portion of the charge flow 20. The cylinder head 30 includes the swirl passage 40 connecting the upstream portion 46 of the second port 36 to the downstream portion 44 of the first port 32. The swirl passage 40 is configured divert a part of the second portion of the charge flow 20 from the second port 36 to the first port 32 to generate swirl in the charge flow 20 in the combustion chamber 14 with a remaining part of the second portion of the charge flow 20 being provided to the combustion chamber 14 through the second port 36.

Referring to FIGS. 1-2, internal combustion engine 10 includes a plurality of cylinders 12. Each of the cylinders 12 includes a combustion chamber 14. Internal combustion engine 10 also includes an intake 16 and an exhaust 18 connected to each combustion chamber 14 of cylinders 12. Intake 16 provides a charge flow 20 to combustion chambers 14, and exhaust 18 provides a path for exhaust flow 22 to be expelled from combustion chambers 14.

Engine 10 further includes a cylinder head 30 that extends along one or more of the cylinders 12. Intake 16 includes an intake manifold 26 connected to cylinder head 30. Intake manifold 26 distributes charge flow 20 to the combustion chambers 14 through a plurality of intake ports of cylinder head 30, as discussed further below. An exhaust manifold 28 collects the exhaust output from combustion in the combustion chambers 14 of each of the cylinders 12, and provides the exhaust flow 22 to exhaust 18.

Engine 10 can be any type of engine, and in one specific embodiment is a combustion engine that combusts any suitable fuel and includes a number of cylinders 12 each housing a piston 24. In the illustrated embodiment, engine 10 includes six cylinders connected with intake manifold 26 and exhaust manifold 28 via cylinder head 30. However, any number of cylinders 12 capable of being used for an engine 10 is contemplated. Engine 10 can be an in-line type engine with a single cylinder bank as shown in the illustrated embodiment, or other configuration including V-shaped cylinder arrangements, a W-type engine, or any engine arrangement with one or more cylinders 12. It is contemplated that engine 10 is provided as part of a powertrain for a vehicle (not shown), although other applications are also contemplated and not precluded, such as for gensets and marine applications.

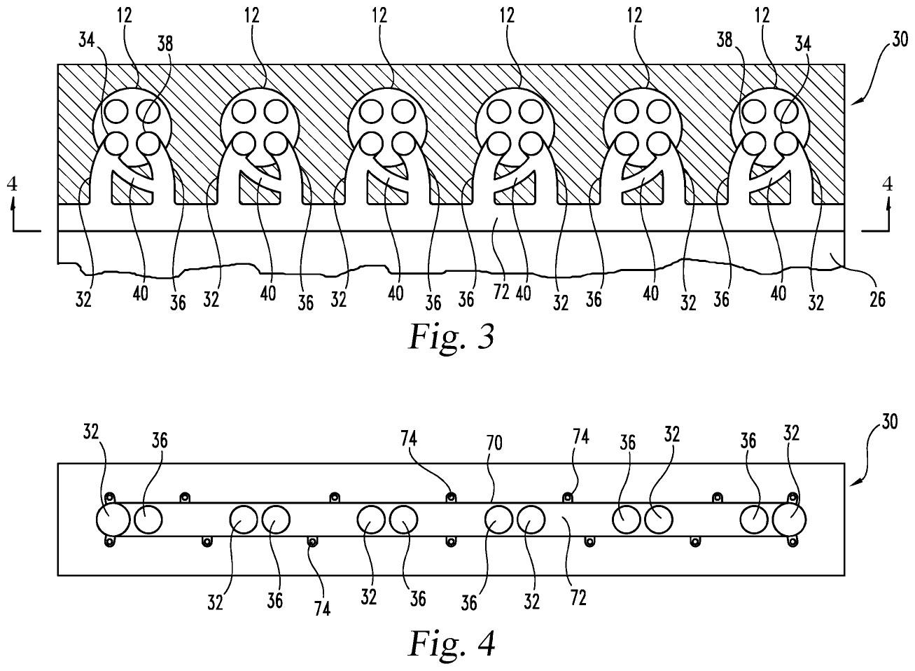

Referring further to FIGS. 3-4, there is illustrated further details of cylinder head 30 according to an embodiment of the present disclosure. In the illustrated embodiment, cylinder head 30 is a unitary body with a plurality of first ports 32, each paired with a corresponding one of a plurality of second ports 36. The paired first and second ports 32, 36 are flow connected to respective ones of the plurality of cylinders 12 to provide charge flow 20 to combustion chambers 14. In addition, each pair of first and second ports 32, 36 is connected to one another with a corresponding one of the plurality of swirl passages 40.

First port 32, second port 36, and/or swirl passage 40 may be formed by casting, drilling, machining, or other forming technique in the cylinder head 30. Cylinder head 30 can be comprised of a single, unitary body sized to extend along all cylinders 12 of engine 10, or divided into two or more parts that span one or more cylinders 12. In addition, cylinder head 30 can include other features not shown in the illustrated embodiments, such as passages, drillings, and other ports for injectors, sensors, fasteners, and the like.

Each of the first ports 32 includes a respective first outlet 34, and each of the second ports 36 includes a respective second outlet 38. The first outlets 34 and second outlets 38 admit charge flow 20 into the corresponding cylinders 12 when intake valves 60, 62 are lifted from their respective valve seats 64, 66. For example, each cylinder 12 includes two intake valves 60, 62 that are opened and closed by a valve opening mechanism (not shown) via a camshaft (not shown.) The opening of the valve(s) 60, 62 allows charge flow 20 to be admitted into the combustion chamber 14 of the respective cylinder 12 through outlets 34, 38.

The cylinder head 30 further includes a flange 70 that extends along one side of cylinder head 30 for connection intake manifold 26. Flange 70 defines a flow passage 72 along the length of cylinder head 30. Flow passage 72 interconnects the first ports 32 and second ports 36 to distribute the charge flow 20 among the connected cylinders 120. Flange 70 can further include a number of tabs 74 projecting outwardly therefrom for receiving fasteners to secure the intake manifold 26 thereto.

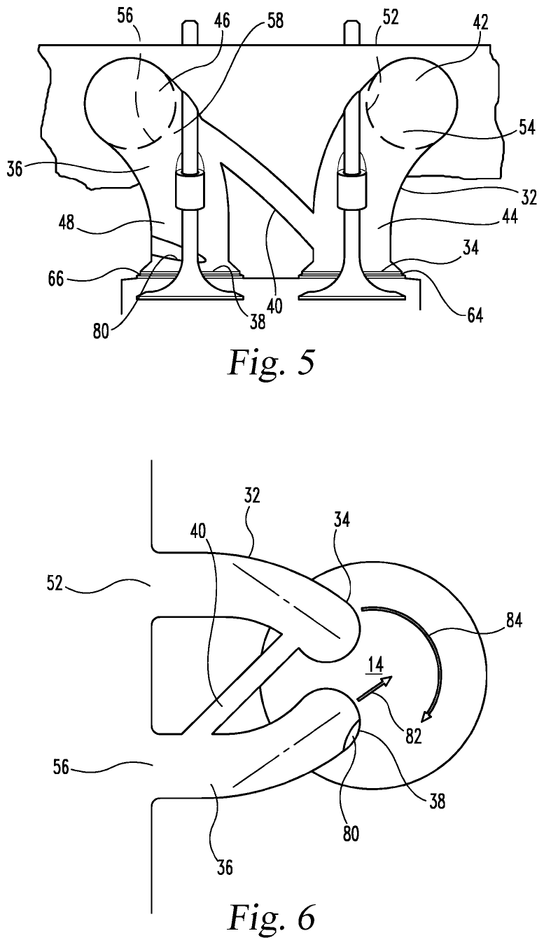

Referring further to FIGS. 5-7, first port 32 includes an upstream portion 42 extending from a first inlet 52, and a downstream portion 44 extending from first outlet 34. Upstream portion 42 is connected to downstream portion 44 with a first bend 54 so that the first outlet 34 lies in a plane that is transversely oriented to a plane in which first inlet 52 lies. Second port 36 includes an upstream portion 46 extending from a second inlet 56, and a downstream portion 48 extending from second outlet 38. Upstream portion 46 is connected to downstream portion 48 with a second bend 58 so that the second outlet 38 lies in a plane that is transversely oriented to a plane in which second inlet 52 lies.

Swirl passage 40 connects the higher pressure upstream portion 46 of second port 36 to a lower pressure downstream portion 44 of first port 32. As a result, any part of the charge flow diverted from second port 36 into swirl passage 40 travels from second port 36 to first port 32 and then is admitted into the combustion chamber 14 through first outlet 34 along with the charge flow 20 that is admitted into first port 32 via first inlet 52. The remaining portion of the charge flow in second port 36 is admitted into combustion chamber 14 through second outlet 38.

In an embodiment, first and second outlets 34, 38 lie in a common plane, and first and second inlets 52, 56 lie in a common plane. In an embodiment, first and second outlets 34, 38 lie in a plane that is orthogonal to the plane in which first and second inlets 52, 56 lie. Other embodiments contemplate other configuration and orientations between the inlets and outlets of the first and second ports 32, 36. For example, first and second outlets 34, 38 may lie in a plane that is obliquely oriented to, or parallel to, the plane in which first and second inlets 52, 56 lie. In still other embodiments, first and second inlets 52, 56 and/or first and second outlets 34, 38 are not co-planar.

In an embodiment, second port 37 includes shielding 80 that partially obstructs the outlet into the combustion chamber 14 formed by second outlet 38. The shielding 80 causes more charge flow 20 to be admitted into combustion chamber 14 from first port 32 than second port 36. Thus, shielding 80 may include a swirl inducing feature or configuration that imparts some swirl characteristic to the portion of charge flow 20 admitted into combustion chamber 14 through second outlet 38, as indicated by arrow 82.

In an embodiment, shielding 80 is located on a side of second port 36 that is opposite of the direction of swirl flow. As a result, the portion of charge flow 20 admitted through second outlet 38 is directed more toward the side of second outlet 38 adjacent first port 32. In addition, the part of charge flow 20 diverted through swirl passage 40 directs the charge flow admitted through first bore 34 in the direction of swirl flow indicated by arrow 84.

In addition, shielding 80 diverts a part of the portion of the charge flow 20 that enters second port 36 through second inlet 56 to enter swirl passage 40. The diverted part of the charge flow 20 enters first port 32 from swirl passage 40 at its downstream portion 44 near first outlet 34 and/or valve seat 64. This diverted part of the charge flow 20 induces a greater swirl in the charge flow in combustion chamber 14 admitted through first outlet 34, as indicated by arrow 84, without significant pumping losses.

Shielding 80 may be any structure that partially obstructs second outlet 38 of second port 36. In certain embodiments, shielding 80 includes one or more swirl inducing features. In certain embodiments, shielding 80 is one or more of a plate, a deflector, a block, a protrusion, a ramp, a spiral, a lip, or other device or configuration that partially obstructs or chokes charge flow 20 from passing through second outlet 38 of second port 36. Shielding 80 may be cast with second port 32, or installed as a separate device in second port 32. In addition, shielding 80 can be located on second port 36 so that the portion of the charge flow admitted through second outlet 38 is deflected in the same swirl direction as the charge flow admitted through first outlet 34. In an embodiment, shielding 80 can be located on a side of second port 36 opposite of first port 32.

In an embodiment, first port 32 tapers in size from flow passage 72 and/or first inlet 52 toward first outlet 34 and combustion chamber 14. Second port 36 also tapers in size from flow passage 72 and/or second inlet 56 toward second outlet 38 and combustion chamber 14. Other embodiments contemplate uniformly sized and/or non-tapered first and second ports 32, 36. As used herein, size may include a cross-sectional area, a diameter, a circumference, and/or a perimeter. In addition or alternatively, first port 32 and second port 36 converge toward one another in a direction away from flow passage 72 toward first and second outlets 34, 38 and/or combustion chamber 14.

In an embodiment, swirl passage 40 is uniform in size from second port 36 to first port 32. Other embodiments contemplate non-uniformly sized and/or tapered swirl passages 40. In an embodiment, swirl passage 40 is inclined from a first location at upstream portion 46 of second port 36 to a second location at downstream portion 44 of first port 32 in a direction toward combustion chamber 14. The inclined swirl passage 40 may be sloped from the first location to the second location in a direction toward the combustion chamber 14.

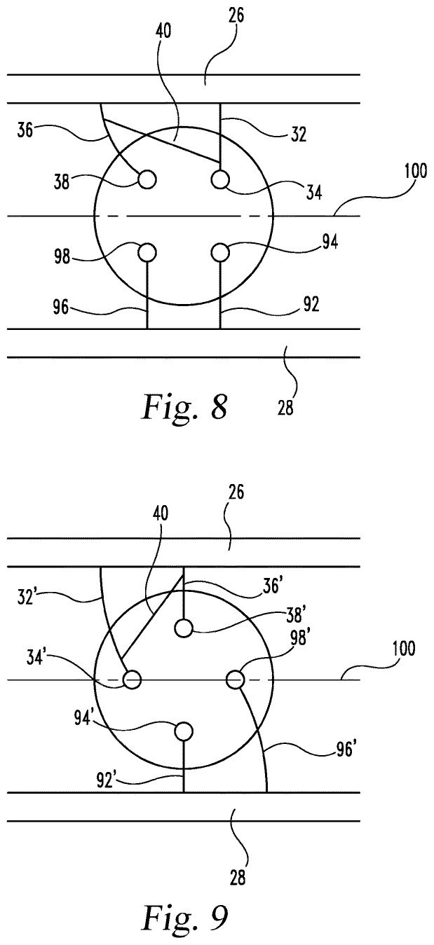

Referring to FIGS. 8-9, examples of intake and exhaust port configurations at the interface with cylinders 12 are shown. For example, in FIG. 8 there is shown first and second outlets 34, 38 for the intake side and first and second inlets 94, 98 for the exhaust side. Outlets 34, 38 and inlets 94, 98 are arranged in a square pattern on opposite sides of a centerline 100 of cylinder 12. The intake ports 32, 36 can be the same or generally the same length from intake manifold 26, and the exhaust ports 92, 96 can be the same or generally the same length from exhaust manifold 28.

In the FIG. 9 embodiment, first and second outlets 34′, 38′and third and fourth inlets 94′, 98′are arranged in a diamond pattern. In this configuration, first outlet 34′and exhaust inlet 98′are opposite one another on centerline 100, and second outlet 38′and exhaust inlet 94′are opposite one another on opposite sides of centerline 100. As a result first outlet 34′is further from intake manifold 26 than second outlet 38′, and exhaust inlet 98′is further from exhaust manifold 28 than exhaust inlet 94′. While the diamond configuration of FIG. 9 may be capable of generating swirl flow without shielding in second port 36′having a swirl inducing feature, swirl passage 40 can be used to enhance or increase the amount of swirl that is generated.

Many aspects of the present disclosure are envisioned. For example, one aspect is directed to an internal combustion engine including at least one cylinder including a combustion chamber; and a cylinder head configured to provide a charge flow to the combustion chamber. The cylinder head includes a first port connected to a first outlet of the first port and a second port connected to a second outlet of the second port. The first port is configured to introduce charge flow into the combustion chamber through the first outlet, and the second port is configured to introduce charge flow into the combustion chamber through the second outlet. The cylinder head includes a swirl passage connecting an upstream portion of the second port to a downstream portion of the first port. The swirl passage is configured to generate a swirl in the charge flow introduced into the combustion chamber through the first outlet with a portion of the charge flow diverted from the second port to the first port through the swirl passage.

In an embodiment, the second port includes shielding that obstructs the second port to divert the charge flow in the second port through the swirl passage. In a refinement of this embodiment, the first port is located on a first side of the second port, and the shielding is located on the second port so the charge flow admitted through the second port is deflected in a same swirl direction as the charge flow admitted through the first port.

In an embodiment, the first port and the second port are each tapered toward the first outlet and the second outlet, respectively. In an embodiment, the upstream portion of the second port is a higher pressure region than the downstream portion of the first port.

In an embodiment, the swirl passage extends from the second port to a location adjacent a valve seat in the first port. In a refinement of this embodiment, the swirl passage includes a uniform diameter from the second port to the first port.

In an embodiment, the internal combustion engine includes an exhaust. The exhaust includes a third port having a first inlet and a fourth port having a second inlet. The third port is configured to receive exhaust flow from the combustion chamber through the first inlet, the fourth port is configured to admit exhaust flow from the combustion chamber through the second inlet. In a refinement of this embodiment, the first and second outlets and the first and second inlets are arranged in a square pattern on the cylinder. In another refinement, the first and second outlets and the first and second inlets are arranged in a diamond pattern on the cylinder.

According to another aspect of the present disclosure, a cylinder head for distributing a charge flow within an internal combustion engine is provided. The cylinder head includes a first port for receiving a first portion of the charge flow and a second port for receiving a second portion of the charge flow. The first port is configured to provide the first portion of the charge flow to a combustion chamber of the internal combustion engine. The cylinder head includes a swirl passage connecting an upstream portion of the second port to a downstream portion of the first port. The swirl passage is configured to divert a part of the second portion of the charge flow from the second port to the first port to generate swirl in the charge flow in the combustion chamber with a remaining part of the second portion of the charge flow being provided to the combustion chamber through the second port.

In an embodiment, the cylinder head includes a plurality of first ports associated with a plurality of combustion chambers, and a plurality of second ports associate with the plurality of combustion chambers. In a refinement of this embodiment, the first port and the second port converge toward one another. In another refinement, the first port and the second port taper in size toward the combustion chamber.

In an embodiment, the first port includes an upstream portion and the downstream portion is connected to the upstream portion with a first bend. The upstream portion of the first port includes a first inlet and the downstream portion of the first port includes a first outlet oriented transversely to the first inlet of the first port. The second port includes a downstream portion and the upstream portion is connected to the downstream portion with a second bend. The upstream portion of the second port includes a second inlet and the downstream portion of the second port includes a second outlet oriented transversely to the second inlet of the second port. In a refinement of this embodiment, the swirl passage is sloped from a first location near the second inlet to a second location near the first outlet.

In an embodiment, the second port includes shielding that partially obstructs the second port to divert charge flow into the swirl passage from the second port. In a refinement of this embodiment, the shielding is configured to induce swirl in the remaining part of the second portion of the charge flow provided to the combustion chamber through the second outlet.

In an embodiment, the cylinder head includes a first intake valve extending into the first port, and a second intake valve extending into the second port. In an embodiment, the swirl passage is uniform in size from the second port to the first port.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An internal combustion engine, the internal combustion engine comprising:
at least one cylinder including a combustion chamber; and
a cylinder head configured to provide a charge flow to the combustion chamber, the cylinder head including:
a first port connected to a first outlet of the first port, the first port being configured to introduce charge flow into the combustion chamber through the first outlet;
a second port connected to a second outlet of the second port, the second port being configured to introduce charge flow into the combustion chamber through the second outlet; and
a swirl passage connecting an upstream portion of the second port to a downstream portion of the first port, the swirl passage being configured to generate a swirl in the charge flow introduced into the combustion chamber through the first outlet with a portion of the charge flow diverted from the second port to the first port through the swirl passage.

2. The internal combustion engine of claim 1, wherein the second port includes shielding that obstructs the second port to divert the charge flow in the second port through the swirl passage.

3. The internal combustion engine of claim 2, wherein the first port is located on a first side of the second port, and the shielding is located on the second port so the charge flow admitted through the second port is deflected in a same swirl direction as the charge flow admitted through the first port.

4. The internal combustion engine of claim 1, wherein the first port and the second port are each tapered toward the first outlet and the second outlet, respectively.

5. The internal combustion engine of claim 1, wherein the swirl passage extends from the second port to a location adjacent a valve seat in the first port.

6. The internal combustion engine of claim 5, wherein the swirl passage includes a uniform diameter from the second port to the first port.

7. The internal combustion engine of claim 1, further comprising an exhaust, the exhaust including:
a third port having a first inlet, the third port being configured to receive exhaust flow from the combustion chamber through the first inlet; and
a fourth port having a second inlet, the fourth port being configured to admit exhaust flow from the combustion chamber through the second inlet.

8. The internal combustion engine of claim 7, wherein the first and second outlets and the first and second inlets are arranged in a square pattern on the cylinder.

9. The internal combustion engine of claim 7, wherein the first and second outlets and the first and second inlets are arranged in a diamond pattern on the cylinder.

10. The internal combustion engine of claim 1, wherein the upstream portion of the second port is a higher pressure region than the downstream portion of the first port.

11. A cylinder head for distributing a charge flow within an internal combustion engine, the cylinder head comprising:
a first port for receiving a first portion of the charge flow, the first port being configured to provide the first portion of the charge flow to a combustion chamber of the internal combustion engine;
a second port for receiving a second portion of the charge flow; and
a swirl passage connecting an upstream portion of the second port to a downstream portion of the first port, the swirl passage being configured to divert a part of the second portion of the charge flow from the second port to the first port to generate swirl in the charge flow in the combustion chamber with a remaining part of the second portion of the charge flow being provided to the combustion chamber through the second port.

12. The cylinder head of claim 11, wherein the cylinder head includes:
a plurality of first ports associated with a plurality of combustion chambers; and
a plurality of second ports associate with the plurality of combustion chambers.

13. The cylinder head of claim 12, wherein the first port and the second port converge toward one another.

14. The cylinder head of claim 12, wherein the first port and the second port taper in size toward the combustion chamber.

15. The cylinder head of claim 11, wherein the swirl passage is uniform in size from the second port to the first port.

16. The cylinder head of claim 11, wherein:
the first port includes an upstream portion and the downstream portion is connected to the upstream portion with a first bend, and the upstream portion of the first port includes a first inlet and the downstream portion of the first port includes a first outlet oriented transversely to the first inlet of the first port; and
the second port includes a downstream portion and the upstream portion is connected to the downstream portion with a second bend, and the upstream portion of the second port includes a second inlet and the downstream portion of the second port includes a second outlet oriented transversely to the second inlet of the second port.

17. The cylinder head of claim 16, wherein the swirl passage is sloped from a first location near the second inlet to a second location near the first outlet.

18. The cylinder head of claim 11, wherein the second port includes shielding that partially obstructs the second port to divert charge flow into the swirl passage from the second port.

19. The cylinder head of claim 18, wherein the shielding is configured to induce swirl in the remaining part of the second portion of the charge flow provided to the combustion chamber through the second outlet.

20. The cylinder head of claim 11, further comprising:
a first intake valve extending into the first port; and
a second intake valve extending into the second port.
